(19) United States
(12) Patent Application Publication
(10) Pub. No.: US 2023/0302974 A1
(43) Pub. Date: Sep. 28, 2023

(54) SEAT TEMPERATURE REGULATOR

(71) Applicant: Panasonic Intellectual Property Management Co., Ltd., Osaka (JP)

(72) Inventors: Daisuke WAKUDA, Kyoto (JP); Shinichi SHIKII, Nara (JP); Yoshihiro SHIMOMURA, Chiba (JP); Yali XIA, Chiba (JP)

(73) Assignee: Panasonic Intellectual Property Management Co., Ltd., Osaka (JP)

(21) Appl. No.: 18/144,587

(22) Filed: May 8, 2023

Related U.S. Application Data
(63) Continuation of application No. PCT/JP2021/040666, filed on Nov. 4, 2021.

(30) Foreign Application Priority Data
Nov. 9, 2020 (JP) 2020-186589

(51) Int. Cl. B60N 2/56

(52) U.S. Cl. CPC B60N 2/5685

(57) ABSTRACT

A seat temperature regulator includes a control device capable of controlling a temperature of a seat for heating and cooling. The control device continuously repeats the heating and cooling within a temperature width range of 10° C. or less.

### CROSS-REFERENCE TO RELATED APPLICATIONS

The present application is a Bypass Continuation of International Application No. PCT/JP2021/040666 filed on Nov. 4, 2021, which is based upon and claims the benefit of priority to Japanese Patent Application No. 2020-186589, filed on Nov. 9, 2020, the entire contents of both applications are incorporated herein by reference.

### TECHNICAL FIELD

The present disclosure relates to a seat temperature regulator.

### BACKGROUND ART

There has conventionally been known a head cooling/heating device (wakefulness inducing device including a headset and a temperature regulator that regulates a temperature of the headset) (see, e.g., JP 2002-125993).

In the conventional configuration described above, it is difficult to simultaneously elicit both a wakefulness maintaining effect and a comfortable feeling.

### SUMMARY

The present disclosure has been made in view of the point described above, and an object of the present disclosure is to provide a seat temperature regulator capable of simultaneously eliciting a wakefulness maintaining effect and a comfortable feeling.

A seat temperature regulator according to an aspect of the present disclosure includes a control device capable of controlling a temperature of a seat for heating and cooling, and the control device continuously repeats the heating and cooling within a temperature width range of 10° C. or less.

### BRIEF DESCRIPTION OF DRAWINGS

The figures depict one or more implementation in accordance with the present teaching, by way of example only, not by way of limitations. In the figures, like reference numerals refer to the same or similar elements.

FIG. 1A is a plan view of a seat temperature regulator 100 according to the present embodiment, while FIG. 1B is a cross-sectional view along a line A-A′ in FIG. 1A in the seat temperature regulator 100.

FIG. 2 is a block diagram of the seat temperature regulator 100 according to the present embodiment.

FIG. 3 is a diagram illustrating an example of positions where temperature regulating portions 110 are disposed in the seat temperature regulator 100 according to the present embodiment.

FIG. 4 is a diagram illustrating body regions of a driver occupying a driver's seat.

FIG. 5 is a diagram illustrating seat temperature conditions and a result of a typical movement of a thermal sensation.

FIG. 6A is a seat temperature condition graph for temperature regulating stimulation that continuously repeats heating/cooling, while FIG. 6B is a seat temperature condition graph of 24° C. constant value stimulation.

FIG. 7 is a diagram illustrating a change between subjective evaluation of a thermal sensation before a task and that after the task.

FIG. 8 is a diagram illustrating a change in average skin temperature under each of the temperature conditions.

FIG. 9 is a diagram illustrating a characteristic obtained by averaging wakefulness levels of all subjects and comparing the average wakefulness levels under the temperature conditions to each other.

FIG. 10A is a diagram illustrating an example of a temperature profile in temperature regulation that continuously repeats heating/cooling and a case where a temperature width and a heating/cooling rate are not constant, FIG. 10B is a diagram illustrating an example of the temperature profile and a case where there is a habituation period for a cooling stimulus, and FIG. 10C is a diagram illustrating an example of the temperature profile and a case where the temperature width and the heating/cooling speed are constant.

FIG. 11A is a diagram illustrating thermal sensations when the seat temperature regulator 100 according to the present embodiment is maintained at 20° C./25° C./30° C./34° C. and placed under 20-30° C./25-35° C. conditions, while FIG. 11B is a diagram illustrating comfortable/uncomfortable feelings when the seat temperature regulator 100 is maintained at 20° C./25° C./30° C./34° C. and placed under 20-30° C./25-35° C. fluctuating conditions.

FIG. 12A is a block diagram of a seat temperature regulator 700 corresponding to a modification of the seat temperature regulator 100 according to the present embodiment, while FIG. 12B is a flow chart illustrating an operation of the modification.

FIG. 13 is a diagram illustrating an example of a pressure distribution in a portion of contact between a seat and a driver during seat occupancy, which is detected with a pressure sheet sensor.

FIG. 14A is a block diagram of a seat temperature regulator 800 corresponding to a modification of the seat temperature regulator 100 according to the present embodiment, while FIG. 14B is a flow chart illustrating an operation of the modification.

FIG. 15A is a block diagram of a seat temperature regulator 900 corresponding to a modification of the seat temperature regulator 100 according to the present embodiment, while FIG. 15B is a flow chart illustrating an operation of the modification.

FIG. 16A is a plan view of a seat temperature regulator 200 corresponding to a modification of the seat temperature regulator 100 according to the present embodiment, while FIG. 16B is a cross-sectional view of a temperature regulating portion 210 of the seat temperature regulator 200.

FIG. 17 is a diagram illustrating a temperature change in thighs and a heat transfer in the temperature regulating portion 210.

FIG. 18 is a plan view of a seat temperature regulator 300 corresponding to a modification of the seat temperature regulator 100 according to the present embodiment.

FIG. 19 is a cross-sectional view of a temperature regulating portion 410 corresponding to a modification of each of the temperature regulating portions 110 according to the present embodiment.

FIG. 20 is a cross-sectional view of a temperature regulating portion 510 corresponding to a modification of each of the temperature regulating portions 110 according to the present embodiment.

FIG. 21A is a plan view of a seat temperature regulator 600 corresponding to a modification of the seat temperature regulator 100 according to the present embodiment, while FIG. 21B is a cross-sectional view of a temperature regulating portion 610 of the seat temperature regulator 600.

FIG. 22 is a diagram obtained by enlarging a cross section of the seat temperature regulator 600 corresponding to a modification of the seat temperature regulator 100 according to the present embodiment.

### DESCRIPTION OF EMBODIMENTS

The following will describe embodiments of a seat temperature regulator according to the present disclosure on the basis of the drawings. Note that all the embodiments disclosed below are exemplary, and it is not intended to place a restriction on the seat temperature regulator according to the present disclosure.

In addition, in the embodiments described below, a description more detailed than necessary may be omitted. For example, a detailed description of a well-known matter and a repeated description of substantially the same configurations may be omitted. This is intended to avoid a redundant description more than necessary and thereby allow easy understanding by those skilled in the art.

Discomfort due to a cold sensation is caused by continuation of a state where a skin temperature has lowered. Therefore, it can be considered that, by regularly providing a heating period while performing low-temperature stimulation, it is possible to prevent an excessive skin temperature reduction and suppress the discomfort due to the cold sensation. In addition, by performing such control, it is possible to continuously stimulate a brain-stem reticular formation that controls wakefulness in a brain, and therefore it can be considered that a higher level of wakefulness can be maintained. This is based on a characteristic that the brain-stem reticular formation is less responsive to the same stimulus, but shows strong excitation to a novel stimulus.

From the above, it can be considered that, by performing stimulation that continuously repeats cooling and heating, it is possible to overcome a trade-off between comfort and a wakefulness maintaining effect, which has been a problem thus far, and maintain a high wakefulness level, while maintaining a higher comfort level. Maintenance of wakefulness includes both of elimination of sleepiness (reduce a sleepiness level) and suppression of sleepiness (reducing the probability of an increase in sleepiness level).

A seat temperature regulator according to the present embodiment can control a temperature of a seat for heating/cooling. A chair to be occupied by a user only needs to be a chair to be used for, e.g., desk work, learning, driving, or the like, though not particularly limited. The seat is a seat to be occupied by the user. The seat temperature regulator is disposed in the seat to be occupied by the user. The seat temperature regulator reduces efficiency degradation due to sleepiness and drowsy driving. In addition, since the seat temperature regulator is a device capable of providing a thermal sensation, the seat temperature regulator can also be used for uses not intended for awakening. The seat temperature regulator may also be used for the purpose of comfort, refreshment, or relaxation, such as for the purpose of providing a cool sensation in a hot environment or for the purpose of providing a warm sensation in a cold environment.

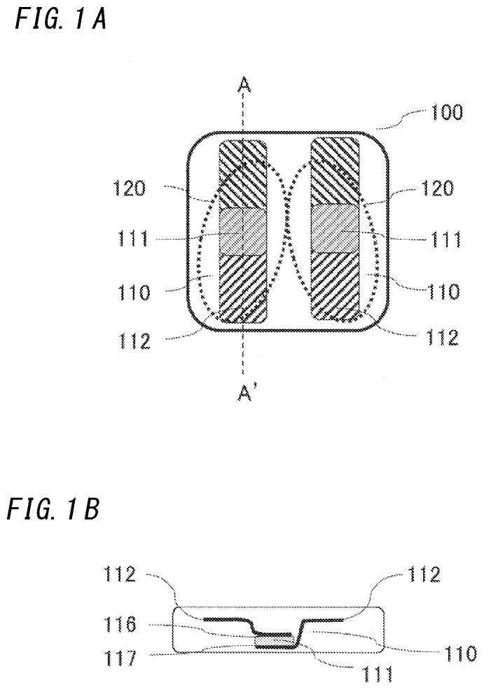

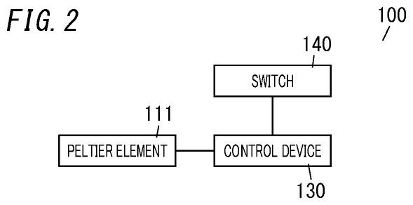

FIG. 1A is a plan view of a seat temperature regulator 100 according to the present embodiment. FIG. 1B is a cross-sectional view of the seat temperature regulator 100 according to the present embodiment. FIG. 1B is a cross-sectional view at a position along a broken line A-A′ illustrated in FIG. 1A. FIG. 2 is a block diagram of the seat temperature regulator 100.

As illustrated in FIGS. 1A, 1B, and 2, the seat temperature regulator 100 includes temperature regulating portions 110, a control device 130, and a switch 140.

The control device 130 is connected to the temperature regulating portion 110 to control a temperature of each of Peltier elements 111 present in the temperature regulating portions 110. The control device 130 can control a current value in each of the Peltier elements 111 and reverse a direction of a current.

The switch 140 is connected to the control device 130, and has a role (function) of switching a power source of the control device 130.

Each of the temperature regulating portions 110 includes the Peltier element 111 and heat conducting sheets 112. The temperature regulating portion 110 is a portion in which a temperature change actually occurs in the seat temperature regulator 100. The temperature regulating portion 110 receives an electric signal from the control device 130 to be able to change a temperature of the seat at a given change rate through a temperature change in the Peltier element 111. The temperature regulating portions 110 are preferably placed in portions (regions 120) immediately below thighs of a driver. This is because the portions (regions 120) immediately below the thighs of the driver are portions that reliably come into contact with a seat when the driver is seated. In addition, since the thighs have large volumes and large heat capacities, a temperature change takes time, and a thermal sensation felt in response to a rapid cooling stimulus is small. Thus, thermal discomfort is less likely to be given thereto, and therefore the portions immediately below the thighs are preferred as positions where the temperature regulating portions 110 are placed.

Note that FIG. 1A illustrates a case where the two temperature regulating portions 110 are provided, but the temperature regulating portions 110 are not limited to the case in FIG. 1A. For example, the number of the temperature regulating portions 110 is not limited to 2, and may also be 1 or 3 or more.

Each of the Peltier elements 111 is a means that performs heat conversion. Note that the means that performs the heat conversion is not limited to the Peltier element. As the means that performs the heat conversion, e.g., a device having a heat pump function can also be used. The means that performs the heat conversion may also be a means using a combination of compression/expansion of a gas and heat conversion, an element using a Peltier effect, or the like. The heat conversion means such as the means using a heat pump or an element using the Peltier effect is generally referred to as a “heat conversion device”. In general, the Peltier element is highly rigid, and has a breakable property. Accordingly, by embedding the Peltier element 111 not in the vicinity of a seat surface, but in the inside thereof, it is possible to reduce concentration of a stress. In addition, by using a bendable-type element as the Peltier element 111, it is possible to inhibit cracking of the element. Moreover, a direction in which the Peltier element 111 is disposed with respect to the seat surface is preferably such that, e.g., the Peltier element 111 is disposed perpendicularly to the seat surface. This can further reduce the concentration of the stress on the Peltier element 111 and inhibit the cracking.

As illustrated in FIG. 1B, the heat conducting sheets 112 are placed on an upper surface and a lower surface of the one Peltier element 111 in the temperature regulating portion 110. The upper surface and lower surface of the Peltier element 111 are defined such that, as illustrated in FIG. 1B, one surface (first surface) of the Peltier element 111 is an upper surface 116, while a surface (second surface) facing the upper surface 116 is a lower surface 117. For example, even in a state where the Peltier element 111 is disposed to be vertically erect, the definitions of the upper surface and lower surface remain unchanged. In other words, the “upper” and “lower” used herein do not mean “upper” and “lower” in a direction perpendicular to the ground. Thus, the two heat conducting sheets 112 are placed for the one Peltier element 111. Each of the heat conducting sheets 112 is placed immediately below a portion of a body. In this case, the “immediately below a portion of a body” also includes a case where the heat conducting sheets 112 are disposed on a back region. In other words, the “immediately below” used herein does not mean “immediately below” in the direction perpendicular to the ground. To reduce heat resistance, each of the heat conducting sheets 112 is preferably present at a place as close as possible to the body. Preferably, each of the heat conducting sheets 112 is made of a material having a high heat conductivity and is, e.g., a metal plate, particularly a copper plate or an aluminum plate. For example, the heat conducting sheet 112 is a carbon-based sheet, particularly a graphite sheet or a carbon nanotube sheet. For example, the heat conducting sheet 112 is a tubular heat pipe or a flexible heat pipe. In addition, since the heat conducting sheet 112 is disposed close to the body, a small rigid heat conducting sheet does not impair comfort of the user. For the same reason, the heat conducting sheet 112 may further have an air permeability, and the heat conducting sheet 112 in this case is a mesh-type sheet made of a material having a high heat conductivity, a woven sheet, or a sheet having a punched hole for air permeation.

As illustrated in FIGS. 1A and 1B, the plurality of heat conducting sheets 112 includes a first heat conducting sheet 112 (left heat conducting sheet 112 in FIG. 1A) and a second heat conducting sheet 112 (right heat conducting sheet 112 in FIG. 1A). The first heat conducting sheet 112 is in contact with the Peltier element 111. The second heat conducting sheet 112 is in contact with the Peltier element 111. The Peltier element 111 has an upper surface (first surface) 116 and a lower surface (second surface) 117 that face each other in an up-down direction (predetermined direction). The first heat conducting sheet 112 has a first portion and a second portion. The first portion is in contact with the first surface of the Peltier element 111. The second portion is located to be farther from the Peltier element 111 than the upper surface 116 in the up-down direction. The second heat conducting sheet 112 has a third portion and a fourth portion. The third portion is in contact with the lower surface 117 of the Peltier element 111. The fourth portion is located to be opposite of the lower surface 117 from the Peltier element 111 in the up-down direction. As illustrated in FIGS. 1A and 1B, the fourth portion of the second heat conducting sheet 112 is in line with the second portion of the first heat conducting sheet 112 in a plan view from the up-down direction.

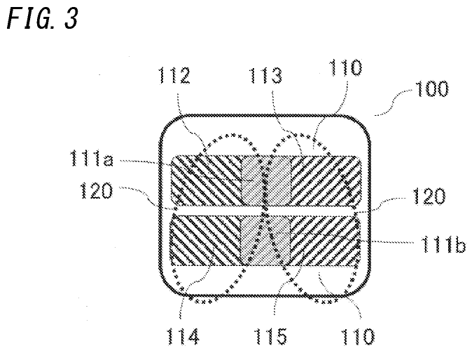

Note that FIG. 1A illustrates a case where the one temperature regulating portion 110 is placed so as to heat/cool one thigh, but the placement of the temperature regulating portion 110 is not limited to the placement illustrated in FIG. 1A. For example, the temperature regulating portion 110 may also be placed as illustrated in FIG. 3. FIG. 3 illustrates an example of a position at which the temperature regulating portion 110 is disposed in the seat temperature regulator 100 according to the present embodiment. All the heat conducting sheets in FIG. 3 are not denoted by the same reference sign, and FIG. 3 illustrates four separate heat conducting sheets 112, 113, 114, and 115. The temperature regulating portion 110 in FIG. 3 is disposed such that the one temperature regulating portion 110 heats/cools both thighs.

Note that, in the case of disposing a plurality of the temperature regulating portions 110, drive control of Peltier elements 111a and 111b disposed in the respective temperature regulating portions 110 can independently be performed. The control device 130 can optionally set periods at which current values and current directions in the respective Peltier elements 111a and 111b are to be reversed. For example, when the periods at which the respective current values and current directions in one Peltier element 111a and another Peltier element 111b are to be reversed are set to be the same in FIG. 3, the heat conducting sheet 112 and the heat conducting sheet 114 are simultaneously heated or cooled, while the heat conducting sheet 113 and the heat conducting sheet 115 are simultaneously cooled or heated. This enhances a thermal stimulation effect to be able to promote effective wakefulness maintenance.

Specifically, when the heat conducting sheet 112 and the heat conducting sheet 114 are simultaneously heated, the heat conducting sheet 113 and the heat conducting sheet 115 are simultaneously cooled. When the heat conducting sheet 112 and the heat conducting sheet 114 are simultaneously cooled, the heat conducting sheet 113 and the heat conducting sheet 115 are simultaneously heated.

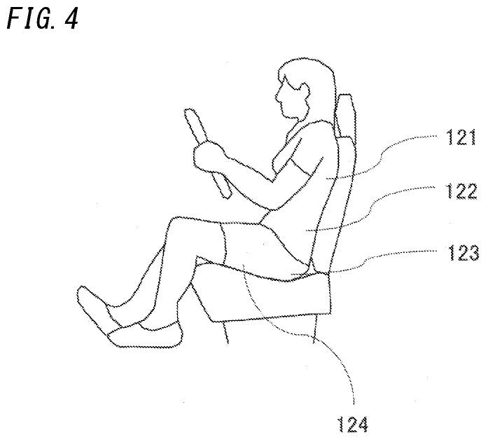

FIG. 4 is a diagram illustrating body regions of the driver occupying a driver's seat. FIG. 4 illustrates respective positions of a back 121, a waist 122, a hip 123, and a thigh 124 of the driver. A position at which the seat temperature regulator 100 (see FIG. 2) is to be disposed is not particularly limited as long as the position is a place where the user (driver) and the sheet are in contact with each other. When the seat temperature regulator 100 is disposed in a seat back, it is possible to give a heating/cooling stimulation to the back 121 and, when the seat temperature regulator 100 is disposed in a seating surface of the seat, it is possible to give the heating/cooling stimulation to the hip or the thigh 124. Among them, the thigh 124 is a region having a large volume and a large heat capacity, and accordingly a temperature change takes time, fluctuations in a thermal sensation felt are slow, and heating discomfort is less likely to be given thereto.

The temperature regulating portion 110 may also be present at each of a plurality of positions. When the temperature regulating portions 110 are present at the plurality of positions, regions where temperature regulation is to be performed or timings at which the temperature regulation is to be performed may also be varied. For example, it is possible to recognize an attitude of the user using a sheet-type pressure sensor or a camera, and vary a place where the temperature regulation is to be performed depending on a region in contact with the seat.

Hereinbelow, a description will be given of a result of an experiment related to the thermal sensation using the seat temperature regulator 100.

All the following experiment results are obtained with the configurations in FIGS. 1A and 1B. In the following description, a temperature change in the seat is given by the control device 130 of the seat temperature regulator 100.

In order to verify a relationship between a temperature characteristic of a cooling stimulus (modulation cycle and temperature) and the thermal sensation, an experiment was conducted in which a cooling rate and a reached temperature were varied, and thermal sensations felt at that time were found out. Subjects were 10 males in their 20 s to 50 s, and transitions of thermal sensations under five different sheet temperature conditions shown in Table 1 were compared to each other in a laboratory maintained at 24° C. An initial temperature was set at 26° C. by reference to a comfort zone defined by the American Society of Heating, Refrigeration, and Air Conditioning Engineers. Under the idea that, as the cooling rate is faster, a cold sensation is less likely to be felt, on the basis of a maximum change rate of −3° C./minute that can be provided by the present seat temperature regulator (seat temperature regulator 100), three conditions of −1° C./minute, −3° C./minute, and −0.5° C./minute were set. During a test period, each of the subjects followed the cues of a test supervisor to orally state “thermal sensations” of the seat temperature regulating portions (temperature regulating portions 110) at intervals of once every 10 seconds. The thermal sensations were rated on a 9-point scale from −4 (very cold) to 4 (very hot). This allowed the thermal sensations felt by the subjects to be known in real time.

TABLE 1

| | Initial | | Reached | Thermal |
|---|---|---|---|---|
| Condition | Temperature | Cooling Rate | Temperature | Sensation |
| 1 | 26° C. | −0.5° C./minute | 20° C. | −2.9 |
| 2 | 26° C. | −1° C./minute | 20° C. | −2.5 |
| 3 | 26° C. | −3° C./minute | 20° C. | −2.4 |
| 4 | 26° C. | −3° C./minute | 22° C. | −2.0 |
| 5 | 26° C. | −3° C./minute | 24° C. | −1.4 |

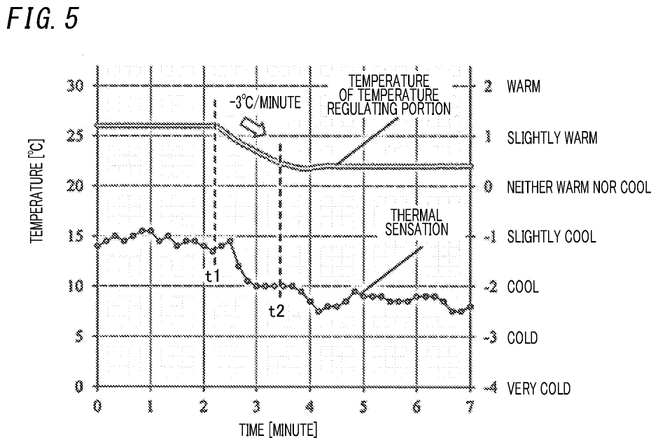

FIG. 5 illustrates seat temperature conditions and a typical movement of the thermal sensation. FIG. 5 illustrates the seat temperature conditions and a result under CONDITION 4 as a result of the typical movement of the thermal sensation. The thermal sensation in FIG. 5 was obtained by plotting average values of the 10 subjects, and vertical dotted lines represent a start point t1 and an end point t2 of a temperature change. The thermal sensation begins to decrease after a while after the temperature change is started by the control device 130, and reaches −2 (cool) at a time point when 22° C. is reached (the end point t2 of the temperature change). Thereafter, the thermal sensation continues to decrease even though there is no more temperature change.

Table 1 shows the thermal sensations when predetermined reached temperatures were reached (the end point t2 of the temperature change) under the respective seat temperature conditions. When CONDITIONS 1 to 3 were compared to each other, it was understood that, even though all of the reached temperatures were 20° C., the cold sensation was less likely to be felt under each of CONDITIONS 2 and 3 under which the cooling rate was high than under CONDITION 1. This may be considerably because, due to the large heat capacity, a temperature change across the entire thigh takes time, and the cold sensation was blunted. From the foregoing, it can be considered that, after the temperature of the seat is rapidly lowered by the control device 130 to decrease to a predetermined temperature, by increasing the temperature without maintaining the seat at a lower temperature, it is possible to maximally suppress the cold sensation/uncomfortable feeling to be given.

When CONDITIONS 3 to 5 are further compared to each other, it can be understood that, as the reached temperature was lower, the thermal sensation was lower, and the subjects felt cold. In the thermal sensation, −2 means coolness, and is in a comfortable range, but a value under −2 is in a cold range to cause discomfort. From the foregoing, it can be considered that, through control of the cooling rate to −3° C./minute and temperature control of a lower limit reached temperature to 22° C. by the control device 130, it is possible to perform temperature modulation that does not cause discomfort.

From these studies, it was derived that an optimum condition for a temperature profile in cooling stimulation performed by the control device 130 is such that a lower limit is set to 22° C., an upper limit is set to 26° C., and heating/cooling is continuously repeated at a change rate of 3° C./minute between the upper limit and the lower limit.

In order to verify an awakening effect achieved by temperature regulating stimulation in which the derived heating/cooling is continuously repeated, the following subject experiment was conducted. The subjects were 7 males in their 20 s and, in a constant-temperature room maintained at 22° C., transitions of wakefulness levels under two different seat temperature conditions were compared to each other.

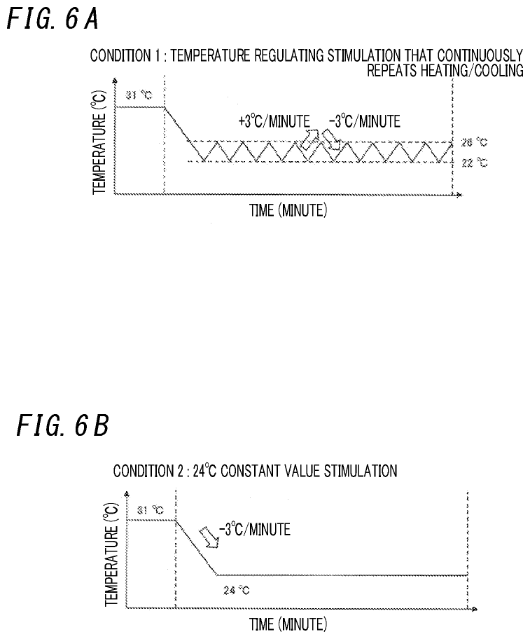

FIGS. 6A and 6B respectively illustrate the two different seat temperature conditions.

To control a mental load on each of the subjects, the subject performed a given task for 24 minutes in a sitting position. As the task, a tracking task was performed in which the subject used a mouse cursor to keep track of a point that regularly moved on a display placed in front of the subject.

In order to suppress factors disturbing the wakefulness level, a heating condition was set at 22° C.±1° C., an illumination condition was set at 100 lx±10%, and a CO₂ concentration (carbon dioxide concentration) was set at 1500 ppm or less. The uniformed clothing conditions were long-sleeved shirts, sweatshirt tops and bottoms, socks, and underwear. In addition, as a precaution, each of the subjects was instructed to have a sufficient period of sleep on the previous day.

In order to evaluate a relationship between a change in skin surface temperature and the resulting thermal sensation, skin temperature sensors were attached to the individual regions of the body according to a Hardy-Dubois 7-point method, and an average skin temperature (average skin temperature=0.07×head+0.14×forearm+0.05×hand+0.35×belly+0.19×thigh+0.13×lower leg+0.07×foot) was calculated.

The thermal sensation was subjected to subjective evaluation using VAS (Visual Analogue Scale) before and after the start of the task. Using a VAS 10 cm line segment, a subjective degree responding to a question was rated by marking on the line.

When the temperature regulation is not performed, it is shown that the seat occupied by the subject is maintained at about 31° C. Accordingly, 31° C. was set as an initial temperature in this study. Under CONDITION 1, after the control device 130 cooled the seat, within a temperature width range of 4° C. or less which was equal to or less than a temperature before the cooling and in which an upper limit was 26° C. and a lower limit temperature was 22° C., heating/cooling was continuously changed at a change rate of ±3° C./minute between the upper limit and the lower limit. Under CONDITION 2, after the control device 130 cooled the seat, low-temperature constant value stimulation was performed at 24° C. corresponding to a time-averaged temperature under CONDITION 1. Under either of CONDITIONS, in initial 3.5 minutes, the control device 130 controlled the temperature of the seat to 31° C., and gave each of temperature changes in the middle of the task.

The wakefulness levels of the subjects were defined as five grades: “1 (seemingly not sleepy at all)”; “2 (seemingly slightly sleepy)”; “3 (seemingly sleepy)”; “4 (seemingly rather sleepy)”; and “5 (seemingly very sleepy)”. A transition of the wakefulness level was objectively quantified by an estimator by viewing, from face images of the subjects captured during the task, expressions of the subjects after the end of the experiment and evaluating the wakefulness levels every 5 seconds with accuracy in 0.5 wakefulness-level increments.

As a result of checking time-averaged values of actually measured temperatures and total amounts of heat transfer under the two temperature conditions provided, no significant differences were found, and it was proved that the control device 130 gave thermally equal heating stimuli.

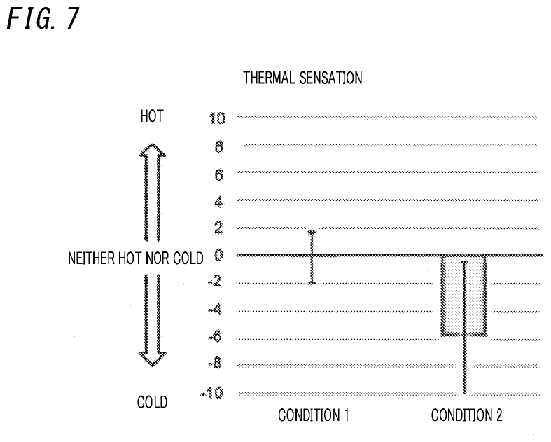

FIG. 7 illustrates a change between the subjective evaluation of the thermal sensation before the task and that after the task. Although no significant difference was found in a comparative test, the subject under CONDITION 2 felt cold, while the thermal sensation under CONDITION 1 was neutral, and it can be considered that the stimulus given to the subject under CONDITION 1 was a stimulus that did not cause discomfort due to a cold sensation.

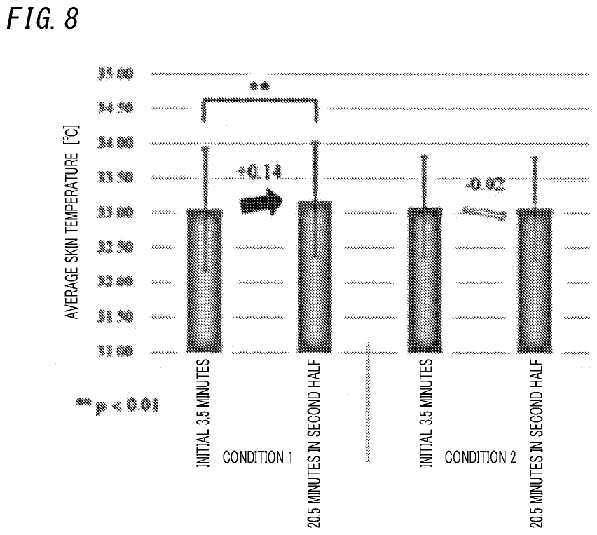

FIG. 8 illustrates a change in average skin temperature under each of the temperature conditions. A left side in each of the conditions has an average value in initial 3.5 minutes, while a right side therein has an average value in 20.5 minutes in the second half of the task. Under CONDITION 2, no significant difference was observed between an initial period of the task and the second half of the task while, under CONDITION 1 under which temperature regulating stimulation that continuously repeats heating/cooling was performed, the average skin temperature (average skin temperature in the second half of the task) after the stimulation was given significantly increased. This also matches a tendency of the thermal sensation, and the result indicated that the thermal sensation was determined by the skin temperature change.

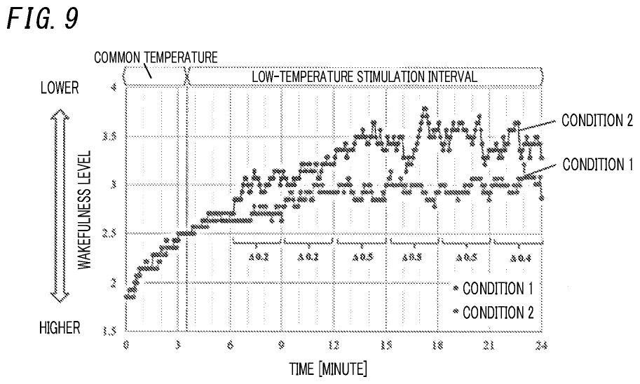

FIG. 9 illustrates a result of averaging the wakefulness levels obtained by the expression evaluation from all the subjects and comparing the average wakefulness levels under the temperature conditions to each other. In order to provide equal wakefulness levels at a final time point (after 3.5 minutes in the example in FIG. 9) in a common temperature, the wakefulness level under CONDITION 1 which is 0.1 lower is displayed. Under CONDITIONS 1 and 2, ever-increasing similar movements are observed until about 6 minutes, and it can be seen that sleepiness has gradually grown. Under CONDITION 2, the movement continues to steadily increase thereafter, and the wakefulness level has reached 3.5 (seemingly sleepy to seemingly rather sleepy) in 13 minutes. Meanwhile, under CONDITION 1, the increase after 6 minutes is gentle, the wakefulness level does not exceed 3.5 over the entire experiment period, and it can be seen that sleepiness is suppressed compared to that under CONDITION 2. The wakefulness levels in 3 minutes were averaged, and a difference between the two conditions was shown in the graph, but the difference started to increase after 12 minutes and, due to the temperature regulating stimulation that continuously repeats heating/cooling, the wakefulness levels were lower by 0.4 to 0.5, and it can be said that the wakefulness maintaining effect was effectively working. This study was conducted in a low-temperature environment at a 22° C. room temperature, and it is possible to further superimpose an effect on a low-temperature awakening effect due to an air conditioner. Therefore, from the result, it can be said that a combined use of the temperature regulating simulation that continuously repeats heating/cooling is also expectable.

The foregoing result has made clear that the temperature regulating stimulation that continuously repeats heating/cooling does not cause discomfort due to a cold sensation, and has a wakefulness maintaining effect more effective than that of the low-temperature constant value stimulation.

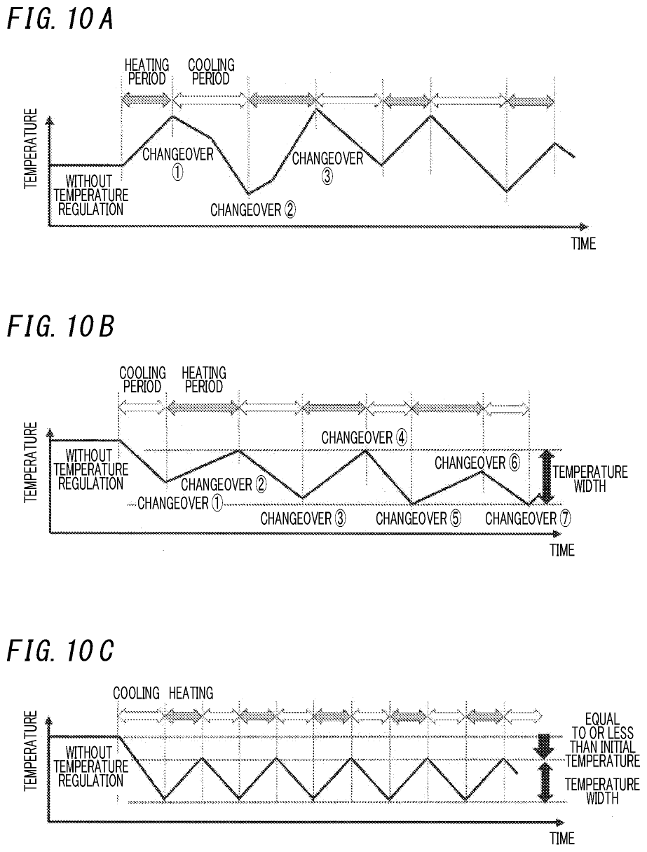

FIGS. 10A to 10C illustrate an example of a temperature profile of temperature regulation that continuously repeats heating/cooling, of which FIG. 10A is a diagram illustrating a case where a temperature width and a heating/cooling rate are not constant, FIG. 10B is a diagram illustrating a case where there is a habituation period for a cooling stimulus, and FIG. 10C is a view illustrating a case where the temperature width and the heating/cooling rate are constant. In the brain, the brain-stem reticular formation controls wakefulness. Due to the characteristic of the brain-stem reticular formation, constant-value stimulation reduces excitation thereof. Meanwhile, the brain-stem reticular formation is sensitive to a novel stimulus. Repeated heating and cooling allows the brain-stem reticular formation to effectively retain excitation and allows a wakeful state to be maintained for a long period. Accordingly, the temperature regulation that continuously repeats heating/cooling mentioned herein refers to temperature control in which a heating period and a cooling period alternately appear, and respective times required for the heating/cooling and respective temperature change rates therefor need not be equal. In addition, the number of times the heating and cooling are changed over (CHANGEOVERS 1, 2, 3, . . . in FIG. 10A) are not particularly limited as long as the number of times is a plurality of number of times but, in order to repetitively give a novel stimulus, the number of times is preferably three or more times, more preferably five or more times, or still more preferably ten or more times. A temperature fluctuation width in the heating/cooling represents a difference between a maximum temperature and a minimum temperature at each of a sequence of changeover points, and the fluctuation width only needs to have a size that allows the subject to alternately feel a warm sensation and a cold sensation. Meanwhile, since the temperature change rate is finite, when the temperature fluctuation width in the heating/cooling is large, the heating/cooling takes time, and a frequency with which a novel stimulus is given decreases. Accordingly, a fluctuation temperature width is preferably equal to or less than 10° C., more preferably equal to or less than 6° C., and still more preferably equal to or less than 4° C.

A temperature when cooling is changed over to heating may be such that, as the habituation period for the cooling stimulus, a changeover is made at a temperature higher than a minimum temperature (CHANGEOVERS 1 and 3 in FIG. 10B) before the minimum temperature is reached (CHANGEOVERS 5 and 7 in FIG. 10B). This keeps the user from being exposed to an extremely low temperature from the first time and thus successfully accustoms the user to the cooling stimulus, and therefore it is possible to reduce distraction resulting from sudden exposure to a strong cold sensation or reduce discomfort with the cold sensation.

After cooling the seat first, the seat temperature regulator 100 may also continuously repeat the heating/cooling at a temperature (temperature WITHOUT TEMPERATURE REGULATION in FIG. 10C) equal to or less than the temperature before the cooling. Exposure to a temperature on a side lower than the temperature before the heating/cooling is effective as awakening stimulation. This is because, on a sensation receptor, the number of cold spots is larger than the number of warm spots, and the cold sensation is more effective as an awakening stimulus. In a temperature width in temperature regulation that continuously repeats heating/cooling, a lower limit temperature is preferably set to 20° C. and an upper limit is preferably set to 30° C. More preferably, the lower limit temperature is set to 22° C. and the upper limit is set to 26° C. This is because, since the temperature width is a temperature range that does not give strong cold and warm sensations, no heating discomfort is felt.

The temperature change rate in temperature regulation that continuously repeats heating/cooling is preferably 1° C./minute or more, or more preferably 3° C./minute or more. When the change rate is 1° C./minute or more, it is possible to ease a cooling stimulus and reduce discomfort due to a cold sensation. Meanwhile, when the change rate is 3° C./minute or more, it is possible to further ease the cooling stimulus and reduce the discomfort due to the cold sensation.

As illustrated in FIGS. 10A and 10B, the control device 130 may have a function of continuously repeating the heating and cooling such that a length of the heating period is different from a length of the cooling period. As illustrated in FIG. 10C, the control device 130 may have a function of continuously repeating the heating and cooling such that a length of the heating period is identical to a length of the cooling period. As illustrated in FIGS. 10A and 10B, the control device 130 may have a function of continuously repeating the heating and cooling such that the change rate of the heating is different from the change rate of the cooling. As illustrated in FIG. 10C, the control device 130 may have a function of continuously repeating the heating and cooling such that the change rate of the heating is identical to the change rate of the cooling.

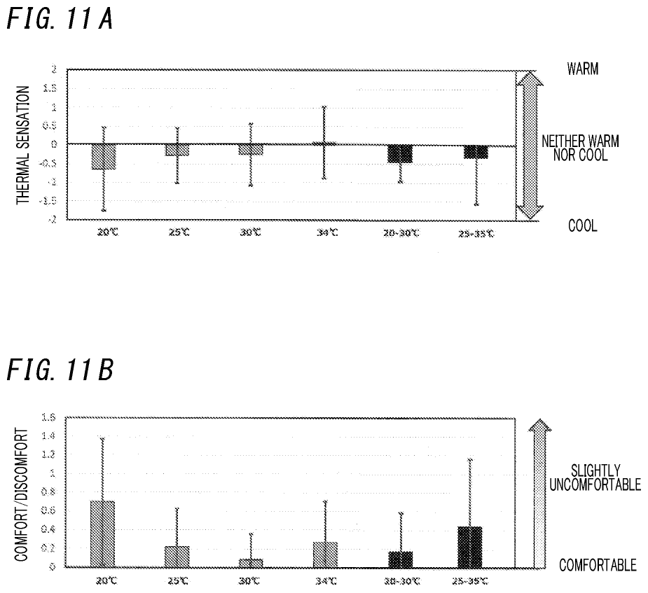

FIG. 11A is a diagram illustrating thermal sensations when the seat temperature regulator 100 was maintained at 20° C./25° C./30° C./34° C. and placed under 20-30° C./25-35° C. fluctuating conditions, while FIG. 11B is a diagram illustrating comfortable/uncomfortable feelings when the seat temperature regulator 100 was maintained at 20° C./25° C./30° C./34° C. and placed under 20-30° C./25-35° C. fluctuating conditions. All the experiment results in FIGS. 11A and 11B were obtained with the configurations in FIGS. 1A and 1B. FIGS. 11A and 11B illustrate a result of subjective evaluation of the thermal sensations and the comfortable feelings after a temperature of the seat temperature regulator 100 was maintained at each of 20° C./25° C./30° C./34° C. for 10 minutes and after the temperature was varied by continuously repeating heating/cooling within temperature ranges of 20-30° C./25-35° C. Table 2 shows indices of the thermal sensations. Table 3 shows indices of the comfortable feelings. In FIG. 11A, the thermal sensations at 20° C., 25° C., and 30° C. show that the subjects were allowed to feel slightly cooler than neutral, and can be expected to have a wakefulness maintaining effect. When the temperature range is 20° C.-30° C., the thermal sensation and the uncomfortable feeling are lower than when the temperature range is 25° C.-35° C. An average value of the comfortable feelings at all the maintenance temperatures in FIG. 11B does not exceed 1 (SLIGHTLY UNCOMFORTABLE). From the results in FIGS. 11A and 11B, it can be seen that a temperature range that allows a wakefulness maintaining effect to be obtained without discomfort is a 10° C. temperature range with an upper limit of 30° C. and a lower limit of 20° C.

TABLE 2

| −3 | −2 | −1 | 0 | 1 | 2 | 3 |
|---|---|---|---|---|---|---|
| Cold | Cool | Slightly | Neither | Slightly | Warm | Hot |
| | | Cool | Warm Nor | Warm | | |
| | | | Cool | | | |

TABLE 3

| 0 | 1 | 2 | 3 |
|---|---|---|---|
| Comfort | Slightly | Uncomfortable | Very |
| | Uncomfortable | | Uncomfortable |

A device that continuously repeats heating/cooling to provide this temperature regulating stimulation is not particularly limited. For example, seat temperature regulation may be that using an air conditioner, that using a combination of an air conditioner and an electrothermal heater, or that using a Peltier element. Among them, the seat temperature regulator 100 using the Peltier element is one of appropriate methods because heating/cooling changeovers are easy, a high-speed temperature change can be made, and fine temperature control is possible.

(Modifications)

(First Modification)

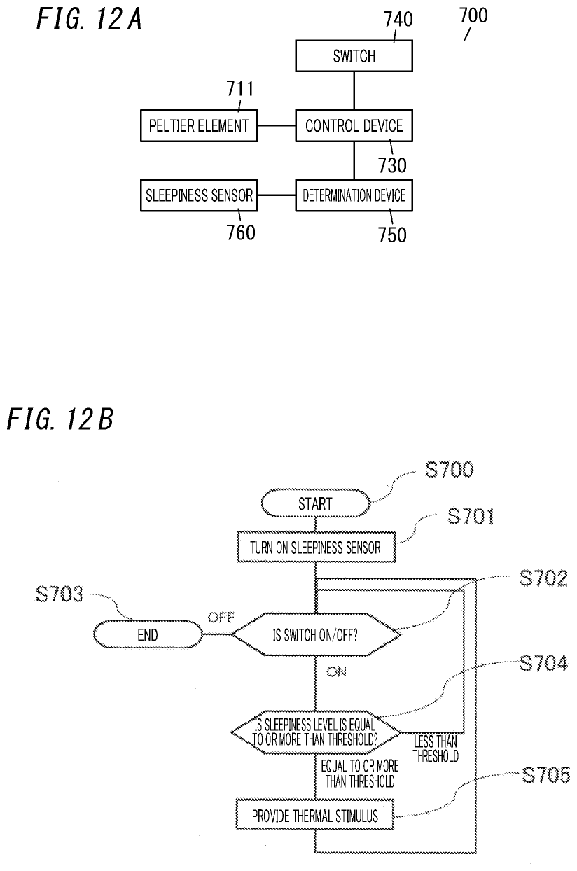

FIG. 12A is a block diagram of a seat temperature regulator 700 corresponding to a modification of the seat temperature regulator 100 according to the present embodiment. FIG. 12B is a flow chart illustrating an operation of the modification. A difference from FIG. 2 is that a determination device 750 and a sleepiness sensor 760 are used. The sleepiness sensor 760 is connected to the determination device 750. The determination device 750 is connected to a control device 730. The control device 730 is connected to each of a switch 740 and the determination device 750. A Peltier element 711 is connected to the control device 730.

The sleepiness sensor 760 detects sleepiness of a user. The sleepiness sensor 760 is not particularly limited, and examples thereof include a camera, a pressure sheet sensor, a motion sensor, a heartbeat sensor, a pulsebeat sensor, and a respiration sensor.

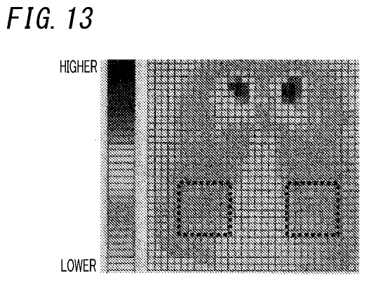

The determination device 750 determines a sleepiness level on the basis of user information obtained from the sleepiness sensor 760. Alternatively, the determination device 750 may also determine the sleepiness level on the basis of the user information obtained not only from the sleepiness sensor 760, but also from a plurality of sensors. The sleepiness level may be a sleepiness level at a certain time point from the past to the present based on information stored in the past or on current information, or may also be a sleepiness level predicted at a certain time point in the future. A determination method is not particularly limited, and a determination is made on the basis of, e.g., the number of blinks of the user obtained from the camera or a change in a gravity position of the user obtained from the pressure sheet sensor. FIG. 13 illustrates an example of a pressure distribution in a portion of contact with a seat during seat occupancy, which is detected with the pressure sheet sensor. In FIG. 13, a dark colored portion has a high pressure, while a light colored portion has a low pressure. The dotted line portions in FIG. 13 correspond to places where the temperature regulating portions 110 are located. The pressure sheet sensor is disposed in the seat to acquire a distribution of a contact pressure between the user and the seat in time series. For example, when it can be determined that discomfort has increased is when the contact pressure between the user and the seat has decreased after the start of temperature regulation. This is because, due to discomfort, the user is seated again so as to move the thighs or the like away from the temperature regulating portions 110. The pressure sheet sensor is not particularly limited, and the pressure may be detected as a change in resistance value or the pressure may also be detected as a change in capacitance. FIG. 13 illustrates a result of an experiment using a capacitance-type pressure sheet sensor.

As illustrated in FIG. 12B, after the start (S700), the seat temperature regulator 700 turns ON a power source of the sleepiness sensor 760 (S701), and determines ON/OFF of a power source of the switch 740 (S702). Then, when the switch 740 is OFF (S702), the operation is ended (S703). When the switch 740 is ON (S702), the determination device 750 determines whether or not the sleepiness level is equal to or more than a threshold (S704). When the determination device 750 detects a sleepiness level equal to or more than the threshold, the seat temperature regulator 700 starts heating/cooling stimulation to recover the user from sleepiness (S705). Meanwhile, when the determination device 750 detects a sleepiness level less than the threshold, the seat temperature regulator 700 does not perform the heating/cooling stimulation, and the sleepiness sensor 760 returns again to a monitoring state.

(Second Modification)

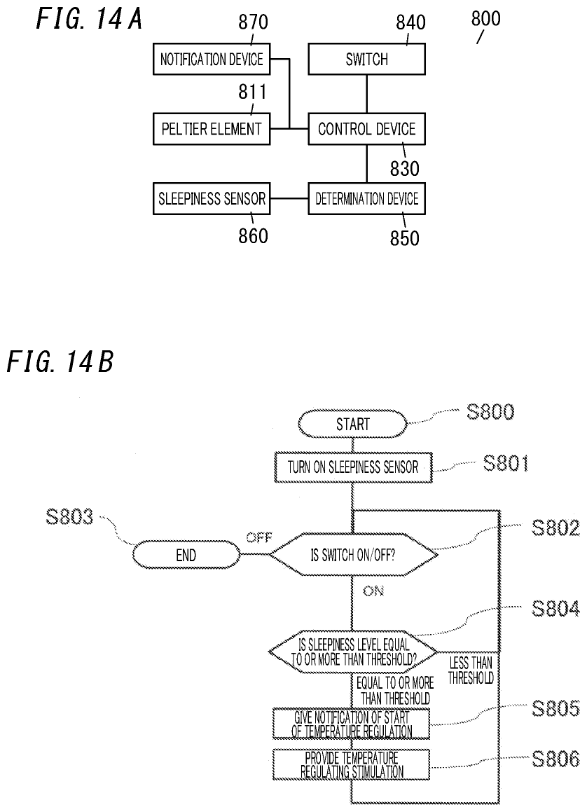

FIG. 14A is a block diagram of a seat temperature regulator 800 corresponding to a modification of the seat temperature regulator 100 according to the present embodiment. FIG. 14B is a flow chart illustrating an operation of the modification. A difference from FIG. 2 is that a determination device 850, a sleepiness sensor 860, and a notification device 870 are used. The notification device 870 is connected to a control device 830. A Peltier element 811 is connected to the control device 830. The sleepiness sensor 860 is connected to the determination device 850. The determination device 850 is connected to the control device 830. The control device 830 is connected to each of a switch 840 and the determination device 850.

The notification device 870 gives a notification of the start of temperature regulation by the seat temperature regulator 800 in advance. On the other words, the notification device 870 gives the notification of the start of temperature regulation that continuously repeats the heating and cooling in advance. When the seat temperature regulator 800 has started the temperature regulation without giving the notification to a user, a sudden temperature change may surprise the user or a feeing of strangeness may confuse the user to possibly impair driving safety. By giving the notification of the start of the temperature regulation in advance, the notification device 870 can prevent the user from being confused. A notification means of the notification device 870 is not particularly limited, and examples thereof include sound/voice, a video, a lamp, vibration, and the like. When the notification means of the notification device 870 is the voice/sound, a speaker serving as the notification device 870 gives a notification that, due to an increased sleepiness level or in order to eliminate sleepiness, seat temperature regulation is to be started.

As illustrated in FIG. 14B, after the start (S800), the seat temperature regulator 800 turns ON a power source of the sleepiness sensor 860 (S801), and determines ON/OFF of a power source of the switch 840 (S802). Then, when the switch 840 is OFF (S802), the operation is ended (S803). When the switch 840 is ON (S802), the determination device 850 determines whether or not the sleepiness level is equal to or more than a threshold (S804). When the determination device 850 detects a sleepiness level equal to or more than the threshold, the notification device 870 gives a preliminary notification of the start of the temperature regulation (S805). Then, the seat temperature regulator 800 starts heating/cooling stimulation to recover the user from sleepiness (S806). Meanwhile, when the determination device 850 detects a sleepiness level less than the threshold, the seat temperature regulator 800 does not perform the heating/cooling stimulation, and the sleepiness sensor 860 returns again to a monitoring state.

(Third Modification)

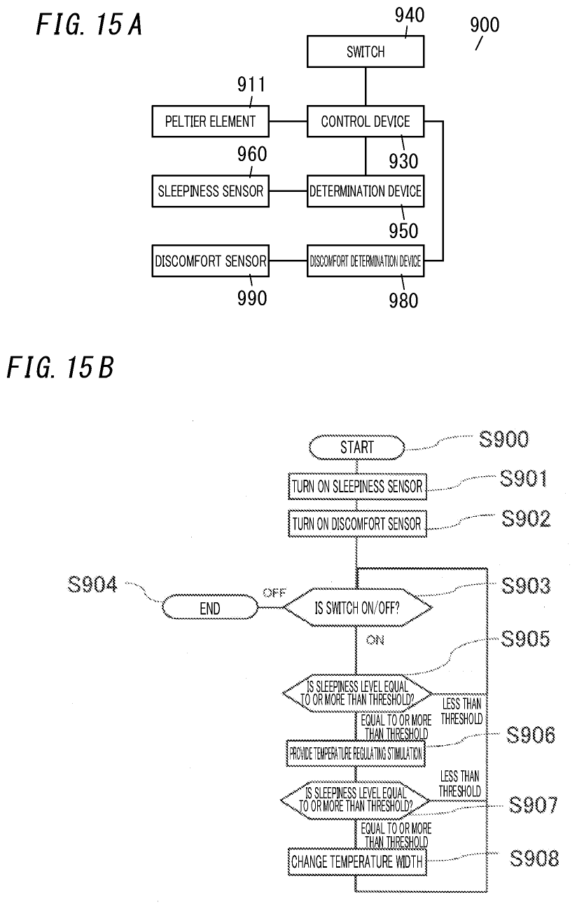

FIG. 15A is a block diagram of a seat temperature regulator 900 corresponding to a modification of the seat temperature regulator 100 according to the present embodiment. FIG. 15B is a flow chart illustrating an operation of the modification. A difference from FIG. 2 is that a determination device 950, a sleepiness sensor 960, a discomfort determination device 980, and a discomfort sensor 990 are used. The discomfort sensor 990 is connected to the discomfort determination device 980. A Peltier element 911 is connected to a control device 930. The determination device 950 is connected to the control device 930. The discomfort determination device 980 is connected to the control device 930. The control device 930 is connected to each of a switch 940 and the determination device 950.

The discomfort sensor 990 acquires discomfort of the user. On the other words, the discomfort sensor 990 detects the discomfort of the user. Examples of the discomfort sensor 990 that acquires the discomfort of the user include a pressure sheet sensor capable of acquiring a contact pressure between the user and a seat. This is because, when a temperature condition in the seat temperature regulator 900 is uncomfortable, the user reduces the contact pressure with the seat. Alternatively, the discomfort sensor 990 may also be a user attitude monitor using a camera. The user attitude monitor detects an attitude of the user. This is because, when the temperature condition in the seat temperature regulator 900 is uncomfortable, the user moves the body away from the seat temperature regulator 900.

The discomfort determination device 980 outputs a level of discomfort from data obtained from the discomfort sensor 990. On the other words, the discomfort determination device 980 detects a discomfort level of the user based on information from the discomfort sensor 990. The control device 930 performs control based on information from the discomfort determination device 980. When the discomfort level is equal to or more than a threshold, the control device 930 reduces a temperature width between an upper limit and a lower limit of temperature regulation that continuously repeats heating/cooling to be able to reduce temperature stimulation. On the other words, when the discomfort level is equal to or more than the threshold, the control device 930 reduces the temperature width between the upper limit temperature and the lower limit temperature of the temperature regulation that continuously repeats the heating/cooling to be less than a temperature width before the discomfort determination device 980 determines the discomfort level.

As illustrated in FIG. 15B, after the start (S900), the seat temperature regulator 900 turns ON a power source of the sleepiness sensor 960 (S901), turns ON a power source of the discomfort sensor 990 (S902), and determines ON/OFF of a power source of the switch 940 (S903). Then, when the switch 940 is OFF (S903), the operation is ended (S904). When the switch 940 is ON (S903), the determination device 950 determines whether or not the sleepiness level is equal to or more than a threshold (S905). When the determination device 950 detects a sleepiness level equal to or more than the threshold, the seat temperature regulator 900 starts heating/cooling stimulation to recover the user from sleepiness (S906). Then, the discomfort determination device 980 determines whether or not a discomfort level is equal to or more than a threshold (S907). When the discomfort determination device 980 detects a discomfort level equal to or more than the threshold, the control device 930 changes a temperature condition (S908).

(Fourth Modification)

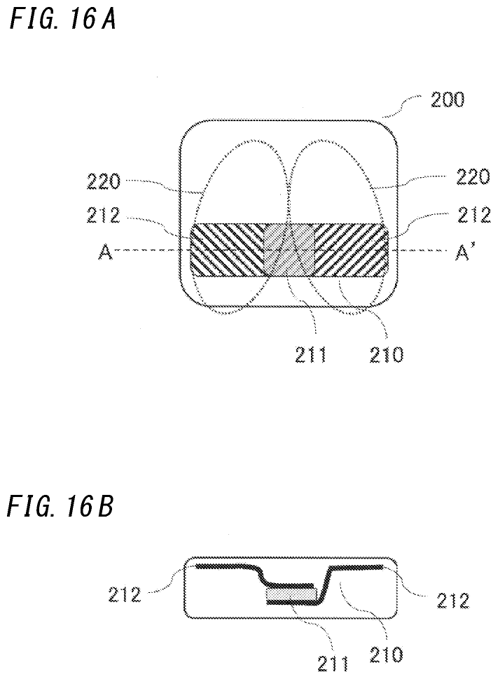

FIG. 16A is a plan view of a seat temperature regulator 200 corresponding to a modification of the seat temperature regulator 100 according to the present embodiment. FIG. 16B is a cross-sectional view of a temperature regulating portion 210 of the seat temperature regulator 200. FIG. 16B is a cross-sectional view at a position along the broken line A-A′ illustrated in FIG. 16A. A difference between the seat temperature regulator 100 and the seat temperature regulator 200 is that the seat temperature regulator 200 uses the only one temperature regulating portion 210. The temperature regulating portion 210 includes a Peltier element 211 and heat conducting sheets 212. However, a means that performs heat conversion is not limited to the Peltier element, and only needs to be a heat conversion device. The heat conducting sheets 212 are placed in portions (regions 220) immediately below thighs corresponding to portions that reliably come into contact with a seat when a driver is seated. The Peltier element 211 is connected to a control device capable of controlling the seat for heating/cooling through a temperature change in the Peltier element 211.

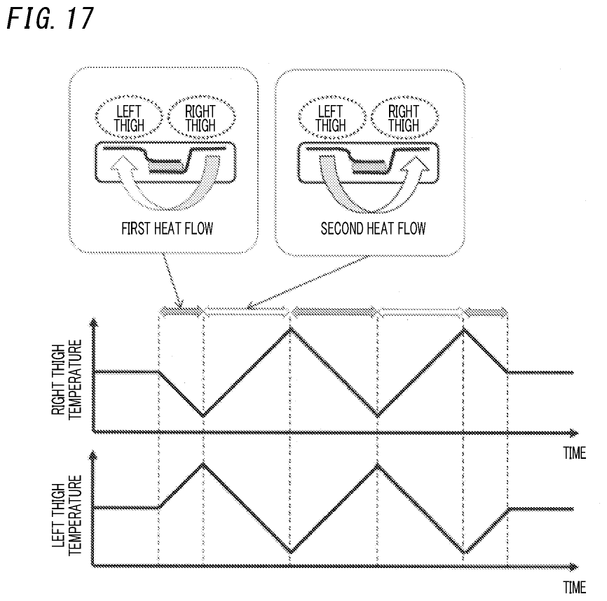

FIG. 17 is a diagram illustrating a temperature change in the thighs and a heat transfer in the temperature regulating portion 210 (see FIG. 16A). The Peltier element 211 (see FIG. 16A) can switch a heat absorbing portion and a heating portion to each other by switching a direction of a current. This not only allows constant cooling or heating, but also allows cooling and heating to be continuously repeated. As a result, the temperature regulating portion 210 can repetitively give a cooling stimulus and a heating stimulus, and consequently a brain-stem reticular formation sensitive to a novel stimulus is effectively activated, and an awakening effect can be enhanced. Times at which the current direction is switched need not be equally spaced periodic times.

When a current is allowed to flow in the Peltier element 211, the Peltier element 211 removes heat from one surface (cooling), and transfers the heat to a surface opposite thereto (heating). The heat conducting sheets 212 are respectively connected to an upper surface and a lower surface of the Peltier element 211. The heat conducting sheets 212 respectively connected to the upper surface and lower surface of the Peltier element 211 are structured to extend in mutually opposite directions. Due to such a configuration, the two heat conducting sheets 212 can provide a state where one of the heat conducting sheets 212 is warm and another of the heat conducting sheet 212 is cold or a state reverse thereto at a time. It can be considered that, since one of the left and right thighs is at a cold temperature and another thereof is at a warm temperature, an awakening effect is enhanced. In the temperature regulating portion 210, by absorbing heat from a portion (region) of a body and giving the absorbed heat to another portion (region) of the body, it is possible to give a temperature difference to a skin surface of the body. Such a structure allows exhaust heat to be used for heating, and therefore it can be considered that an energy efficiency is improved.

(Fifth Modification)

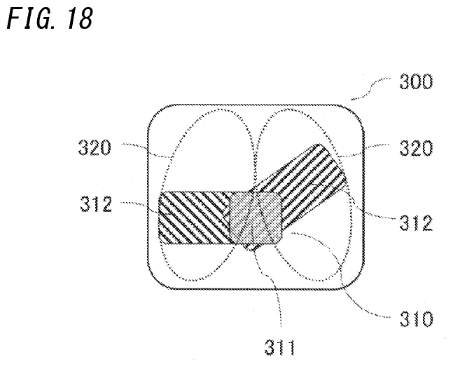

FIG. 18 is a plan view of a seat temperature regulator 300 corresponding to a modification of the seat temperature regulator 100 according to the present embodiment. A difference between the seat temperature regulator 100 and the seat temperature regulator 300 is that the seat temperature regulator 300 uses only one temperature regulating portion 310. The temperature regulating portion 310 includes a Peltier element 311 and heat conducting sheets 312. However, a means that performs heat conversion is not limited to the Peltier element, and only needs to be a heat conversion device. The heat conducting sheets 312 are placed in portions (regions 320) immediately below thighs corresponding to portions that reliably come into contact with a seat when a driver is seated. The heat conducting sheets 312 respectively connected to an upper surface and a lower surface of the Peltier element 311 are not limited to a structure in which the heat conducting sheets 312 extend in mutually opposite directions, and may also be disposed as illustrated in, e.g., FIG. 18. The Peltier element 311 is connected to a control device capable of controlling the seat for heating/cooling through a temperature change in the Peltier element 311.

(Sixth Modification)

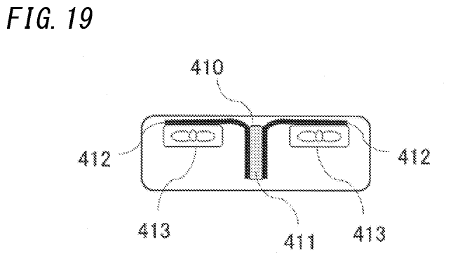

FIG. 19 is a cross-sectional view of a temperature regulating portion 410 corresponding to a modification of each of the temperature regulating portions 110 according to the present embodiment. A difference between the temperature regulating portion 110 and the temperature regulating portion 410 is that the temperature regulating portion 410 includes fans 413. The temperature regulating portion 410 includes a Peltier element 411, heat conducting sheets 412, and the fans 413. However, a means that performs heat conversion is not limited to the Peltier element, and only needs to be a heat conversion device. By disposing the Peltier element 411 such that the Peltier element 411 is erect perpendicularly to surfaces of the heat conducting sheets 412, it is possible to reduce concentration of a stress on the Peltier element 411 and inhibit cracking. By including the fans 413, the temperature regulating portion 410 can efficiently perform heat dissipation.

As illustrated in FIG. 19, the heat conducting sheet 412 is in contact with the Peltier element 411. The fans 413 radiate heat from the heat conducting sheet 112.

(Seventh Modification)

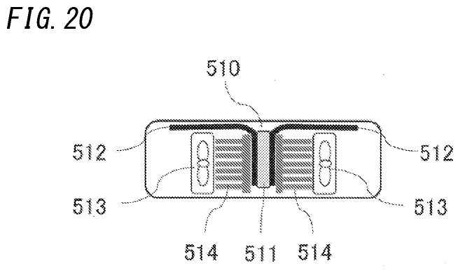

FIG. 20 is a cross-sectional view of a temperature regulating portion 510 corresponding to a modification of the temperature regulating portion 110 according to the present embodiment. A difference between the temperature regulating portion 110 and the temperature regulating portion 510 is that the temperature regulating portion 510 includes fans 513 and heat dissipation fins 514. The temperature regulating portion 510 includes a Peltier element 511, heat conducting sheets 512, the fans 513, and the heat dissipation fins 514. However, a means that performs heat conversion is not limited to the Peltier element, and only needs to be a heat conversion device. By disposing the Peltier element 511 such that the Peltier element 511 is erect perpendicularly to surfaces of the heat conducting sheets 512, it is possible to reduce concentration of a stress on the Peltier element 511 and inhibit cracking. To implement highly accurate temperature control, the Peltier element 511 may also be provided with the heat dissipation fins 514 and the fans 513. By using the heat dissipation fins 514, the temperature regulating portion 510 can efficiently perform the heat conversion.

As illustrated in FIG. 20, the heat dissipation fin 514 is arranged between the heat conducting sheet 512 and the fan 513.

(Eighth Modification)

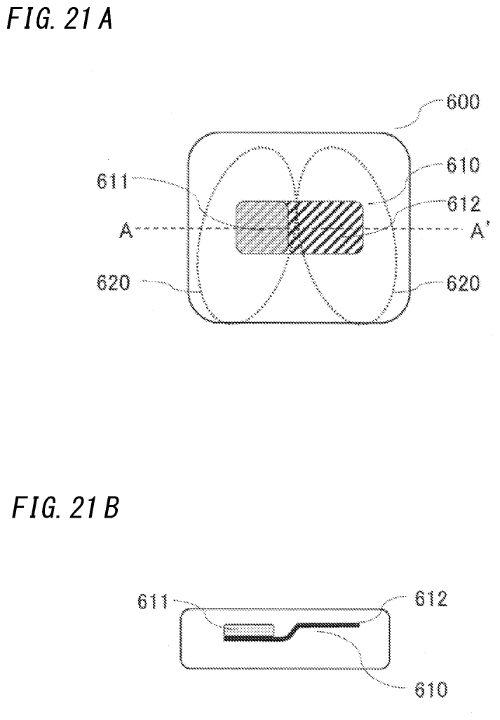

FIG. 21A is a plan view of a seat temperature regulator 600 corresponding to a modification of the seat temperature regulator 100 according to the present embodiment. FIG. 21B is a cross-sectional view of a temperature regulating portion 610 of the seat temperature regulator 600. FIG. 21B is a cross-sectional view at a position along the broken line A-A′ illustrated in FIG. 21A. A difference between the seat temperature regulator 100 and the seat temperature regulator 600 is that the seat temperature regulator 600 uses the only one temperature regulating portion 610 and includes only one heat conducting sheet 612. The temperature regulating portion 610 includes a Peltier element 611 and the heat conducting sheet 612. However, a means that performs heat conversion is not limited to the Peltier element 611, and needs only to be a heat conversion device. The heat conducting sheet 612 is placed in a portion (region 620) immediately below thighs corresponding to a portion that reliably comes into contact with a seat when a driver is seated. The Peltier element 611 is connected to a control device capable of controlling the seat for heating/cooling through a temperature change in the Peltier element 611.

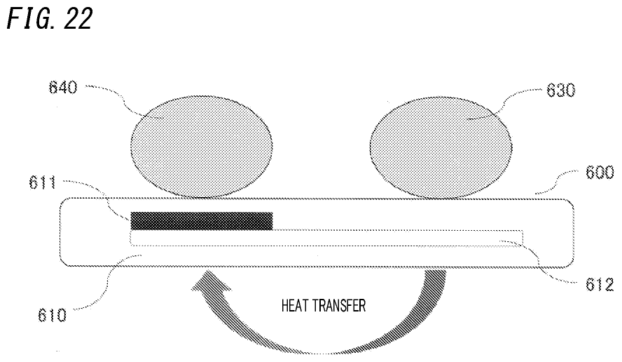

FIG. 22 is a diagram obtained by enlarging a cross section of the seat temperature regulator 600 corresponding to the modification of the seat temperature regulator 100 according to the present embodiment. The seat temperature regulator 600 is placed immediately below a right thigh 630 and a left thigh 640. The Peltier element 611 is placed immediately below the left thigh 640, while the heat conducting sheet 612 is connected to a lower surface of the Peltier element 611. A portion of the heat conducting sheet 612 which is not connected to the Peltier element 611 is placed so as to be located immediately below the right thigh 630. However, the Peltier element 611 only needs to be placed immediately below a region (first region) of a body, while the heat conducting sheet 612 only needs to be placed so as to be located immediately below another region (second region) of the body, and the regions of the body are not specified. In FIG. 22, when the Peltier element 611 is controlled to have, e.g., a warm upper surface and a cold lower surface, the Peltier element 611 removes heat from the lower surface to warm up the upper surface. The Peltier element 611 has the lower surface connected to the heat conducting sheet 612, and consequently a heat transfer occurs in an arrow direction illustrated in FIG. 22, and the heat is removed from the right thigh 630. As a result, the upper surface of the Peltier element 611 is warmed up to warm up the left thigh 640. Meanwhile, the right thigh 630 from which the heat is removed is cooled. The seat temperature regulator 600 can provide a state where the left thigh 640 is warm and the right thigh 630 is cold or a state reverse thereto at a time, and therefore it can be considered that an awakening effect is enhanced. The temperature regulating portion 610 absorbs heat from a portion (region) of the body and gives the absorbed heat to another portion (region) of the body to be able to give a temperature difference to a skin surface of the body. It can be considered that, due to such a structure, exhaust heat can be used for heating, and consequently an energy efficiency is improved.

The seat temperature regulator according to the embodiment and each of the modifications can simultaneously provide a wakefulness maintaining effect and a comfortable feeling. Accordingly, it is possible to use the seat temperature regulator for, e.g., a driver's seat for a driver or the like, and simultaneously maintain wakefulness of a driver and give a comfortable feeling thereto.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A seat temperature regulator comprising:
a control device capable of controlling a temperature of a seat for heating and cooling,
the control device continuously repeating the heating and cooling within a temperature width range of 10° C. or less.

2. The seat temperature regulator of claim 1, wherein the control device continuously repeats the heating and cooling within a temperature width range of 4° C. or less.

3. The seat temperature regulator of claim 1, wherein, after cooling the seat, the control device continuously repeats the heating and cooling at a temperature equal to or less than a temperature before cooling.

4. The seat temperature regulator of claim 1, wherein the control device sets a lower limit temperature to 20° C., while setting an upper limit temperature to 30° C., and continuously repeats the heating and cooling at a change rate of 1° C./minute or more between the upper limit temperature and the lower limit temperature.

5. The seat temperature regulator of claim 1, wherein the control device sets a lower limit temperature to 22° C., while setting an upper limit temperature to 26° C., and continuously repeats the heating and cooling at a change rate of 3° C./minute or more between the upper limit temperature and the lower limit temperature.

6. The seat temperature regulator of claim 1, further comprising:
a Peltier element connected to the control device, wherein
the heating and cooling of the seat is performed by the Peltier element.

7. The seat temperature regulator of claim 1, further comprising:
at least one sensor that detects sleepiness of a user; and
a determination device that determines a sleepiness level of the user based on information from the at least one sensor, wherein
the control device performs control based on information from the determination device.

8. The seat temperature regulator of claim 6, further comprising:
a first heat conducting sheet that is in contact with the Peltier element; and
a second heat conducting sheet that is in contact with the Peltier element, wherein
the Peltier element has a first surface and a second surface that face each other in a predetermined direction,
the first heat conducting sheet has:
a first portion that is in contact with the first surface of the Peltier element; and
a second portion that is located to be farther from the Peltier element than the first surface in the predetermined direction,
the second heat conducting sheet has:
a third portion that is in contact with the second surface of the Peltier element; and
a fourth portion that is located to be opposite of the second surface from the Peltier element in the predetermined direction.

9. The seat temperature regulator of claim 8, wherein the fourth portion of the second heat conducting sheet is in line with the second portion of the first heat conducting sheet in a plan view from the predetermined direction.

10. The seat temperature regulator of claim 1, further comprising:
a discomfort sensor that detects discomfort of a user; and
a discomfort determination device that detects a discomfort level of the user based on information from the discomfort sensor, wherein
the control device performs control based on information from the discomfort determination device.

11. The seat temperature regulator of claim 10, wherein examples of the discomfort sensor include a pressure sheet sensor capable of acquiring a contact pressure between the user and the seat.

12. The seat temperature regulator of claim 10, wherein examples of the discomfort sensor include a user attitude monitor that detects an attitude of the user.

13. The seat temperature regulator of claim 10, wherein when the discomfort level is equal to or more than a threshold, the control device reduces a temperature width between an upper limit temperature and a lower limit temperature of temperature regulation that continuously repeats the heating and cooling to be less than a temperature width before the discomfort determination device determines the discomfort level.

14. The seat temperature regulator of claim 6, further comprising:
a heat conducting sheet that is in contact with the Peltier element; and
a fan that radiates heat from the heat conducting sheet.

15. The seat temperature regulator of claim 14, further comprising a heat dissipation fin that is arranged between the heat conducting sheet and the fan.

16. The seat temperature regulator of claim 1, wherein the control device continuously repeats the heating and cooling such that a length of a heating period is different from a length of a cooling period.

17. The seat temperature regulator of claim 1, wherein the control device continuously repeats the heating and cooling such that a length of a heating period is identical to a length of a cooling period.

18. The seat temperature regulator of claim 1, wherein the control device continuously repeats the heating and cooling such that a change rate of heating is different from a change rate of cooling.

19. The seat temperature regulator of claim 1, wherein the control device continuously repeats the heating and cooling such that a change rate of heating is identical to a change rate of cooling.

20. The seat temperature regulator of claim 1, wherein the control device further includes a notification device that gives a notification of a start of temperature regulation that continuously repeats the heating and cooling in advance.
